(19) United States
(12) Patent Application Publication
(10) Pub. No.: US 2006/0175067 A1
(43) Pub. Date: Aug. 10, 2006

(54) Fire extinguisher sleeve

(76) Inventors: James N. Cover, Irvine, CA (US); Carl A. Cover, Irvine, CA (US)

Correspondence Address: SHELDON & MAK, INC, 225 SOUTH LAKE AVENUE, 9TH FLOOR, PASADENA, CA, 91101, US

(21) Appl. No.: 11/051,404

(22) Filed: Feb. 4, 2005

(51) Int. Cl. A62C 11/00

(52) U.S. Cl. 169/30; 239/71

(57) ABSTRACT

At least one embodiment of the invention pertains to a removable fire extinguisher sleeve that serves to customize the exterior appearance of a fire extinguisher to make it more appealing in various environments or uses. The fire extinguisher sleeve is sized and shaped so that it slides over a fire extinguisher and is kept in place by friction or any other securing means. The sleeve may have a visible graphic, design, logo, color, and/or outer texture that serve to customize it for different environments and uses. The sleeve may also include a fluorescent material that increases its visibility in the darkness to help locate the fire extinguisher. The sleeve may also serve to protect a fire extinguisher, display instructions in multiple languages, and/or house various devices.

### FIELD

Various embodiments of the invention pertain to fire extinguishers. At least one embodiment of the invention pertains to a removable fire extinguisher sleeve that slides on a fire extinguisher and serves to conceal the extinguisher and/or make it blend better in a particular environment.

### BACKGROUND

Fire extinguishers have been used in homes, apartments, hotels, restaurants, offices, theaters, stadiums, cars, boats and other environments for many years. Typically, fire extinguishers are cylindrical containers holding a fire extinguishing material under pressure. A nozzle serves to deliver the fire extinguishing material to extinguish a fire.

Typically, fire extinguisher containers have been painted one solid color, such as red, and instruction and/or warning labels are attached to the container. Laws and regulations also restrict what can be attached to a fire extinguisher. For example, in some locations no additional labels may be attached to a fire extinguisher body other than the ones that may have been attached by the manufacturer. In many locations, fire extinguishers are inspected from time to time by local fire safety officials, who assess the condition of the fire extinguisher, whether it holds the required type and amount of fire extinguishing material, whether the appropriate instructions and/or warning labels are attached to the fire extinguisher, and the placement or location of the fire extinguisher.

While a fire extinguisher serves a useful and important purpose, its appearance (i.e., a red colored cylindrical container) often detracts or clashes with the appearance of the environment in which it is placed. For instance, a red colored fire extinguisher container installed in plain sight in a luxury hotel room may clash with the overall decor and color scheme of the room. However, the fire extinguisher container is typically located where it is easily visible and accessible for use in case of a fire.

However, customizing (i.e., painting) a fire extinguisher to match a particular room can be expensive and inconvenient. Fire extinguisher manufacturers are unlikely to provide a large color selection since it would increase manufacturing costs and the number of consumers who would want a particular color container may be small relative to the overall market for containers. A customer or reseller is also unlikely to repaint a fire extinguisher to a desired color because in the process of repainting the required instruction and/or warning labels would have to be replaced voiding the U.L. certification. Additionally, in some areas (e.g., states, cities), the color of fire extinguisher containers may be regulated or mandated so that a manufacturer can only sell, for example, red fire extinguishers.

Thus, a need exists for an inexpensive and convenient way to customize fire extinguisher containers for a particular environment or purpose while still complying with fire codes, laws, and regulations.

Additionally, fire extinguishers are often mounted outdoors or otherwise exposed to harsh environmental conditions. For example, corrosive environments (e.g., exposure to marine environments, water, or moisture, etc.), scratching of the fire extinguisher's painted exterior, or denting from falls or impacts can cause degradation of the cylinder and lead to premature failure of the fire extinguisher. However, when deployed in an environment, a fire extinguisher should be easily accessible and ready to use. Therefore, a need exists for a way to protect fire extinguishers from premature failures while permitting their unhampered use.

Moreover, fire extinguisher bodies are typically made of metal. When exposed to the in fire situations, the fire extinguisher bodies may become hot making it difficult or uncomfortable to hold. Therefore, a need exists for a fire extinguisher body that does not get hot situations and that still complies with fire laws and regulations.

### SUMMARY OF THE INVENTION

One implementation of the invention provides a sleeve that slides over a fire extinguisher to cover its original color with a more desirable color, image, and/or pattern. The sleeve is designed to slide over the fire extinguisher container for easy installation while permiting viewing of labels and instructions as well as inspection or maintenance of the extinguisher or replacement of the sleeve. The sleeve may be of various colors and include images, graphics, or words that customize it for a particular environment or use. For example, various embodiments of the invention may include a sleeve that has a particular sports team logo, wallpaper pattern, cartoon character image, person's image, and/or graphics.

Another feature of the invention also provides a sleeve that includes a window through which instruction, content, and/or warning labels on the fire extinguisher can be seen.

The sleeve may also form a protective barrier to protect the fire extinguisher from damage.

Yet another feature of the invention provides for a sleeve that includes fluorescent material to improve the visibility of the sleeve and fire extinguisher in the darkness.

An embodiment of the invention also provides a sleeve that includes a folding end that adapts and covers a tapered end of a conventional fire extinguisher.

One embodiment of the invention provides a fire extinguisher sleeve comprising: a shell conforming to the shape of a fire extinguisher body and is configured to be maintained by friction against the fire extinguisher body; and a first material layer deposited on the shell, the first material layer having a different color than the fire extinguisher body to modify the appearance of the fire extinguisher. The first material layer may define a graphic on the shell visible on the exterior surface of the sleeve. The sleeve can be removed from a fire extinguisher without damaging the fire extinguisher or the sleeve. The sleeve may have a cylindrical shape and include at least one opening so the sleeve can be slid on a fire extinguisher. The fire extinguisher sleeve may be made of a flexible or rigid material. The sleeve may also include a see-through window that, when the shell is installed on a fire extinguisher, permits viewing labels attached to the fire extinguisher surface. Lastly, the fire extinguisher sleeve may include two or more parts that attach to each other to form the shell or cover.

Another embodiment of the invention provides a fire extinguisher comprising a fire extinguisher container; and an outer sleeve that covers part of the fire extinguisher container, wherein the outer sleeve can be slid on and slid off the fire extinguisher container intact, the outer sleeve having a color or graphic visible on its external surface that modifies the appearance of the fire extinguisher. The outer sleeve may be a different color than the fire extinguisher container. The outer sleeve may be shaped to cover a neck portion of the fire extinguisher container. The outer sleeve may have a fluorescent color that makes it visible in the darkness. The outer sleeve may also be of a sufficient thickness to protect the fire extinguisher container from damage during a fall or impact. The outer sleeve may also have a textured exterior surface to provide improved gripping of the fire extinguisher. The outer sleeve may be separated into two or more parts along a folding line to create a single fire extinguisher cover. The sleeve may include an inner layer that increases the sleeve's adhesion to the fire extinguisher container.

Yet another embodiment of the invention provides a decorative and removable fire extinguisher cover comprising an outer sleeve conforming to the shape of the fire extinguisher and sized to cover at least a portion of a fire extinguisher body. Wherein the outer sleeve can be maintained by friction against the fire extinguisher body and the outer sleeve can also be installed and/or removed from the fire extinguisher body intact without destruction of the outer sleeve. The outer sleeve may also have a color or graphic visible on its external surface that modifies the appearance of the fire extinguisher body.

Additionally, another feature of the invention provides a decorative and/or protective sleeve or slip for a fire extinguisher hose.

Additionally, the fire extinguisher sleeve may also include a built-in electrical and/or electronic device, such as audio instructions on the use of the fire extinguisher, a smoke detector, a fire alarm, a light source, and/or other devices that may be powered by a built-in power source, such as a battery.

### BRIEF DESCRIPTION OF THE DRAWINGS

FIGS. 1, 2, and 3 illustrate the installation of a sleeve over a conventional, cylindrically-shaped fire extinguisher container according to one embodiment of the invention.

FIG. 4 illustrates a fire extinguisher sleeve having a see-through window according to one embodiment of the invention.

FIGS. 5, 6, and 7 illustrate various sleeve designs, graphics, and/or images according to various embodiments of the invention.

FIG. 8 illustrates a fire extinguisher sleeve having a plurality of layers according to one embodiment of the invention.

FIGS. 9 and 10 illustrate another embodiment of the fire extinguisher sleeve having a first end that can be tailored to cover the neck portion of a fire extinguisher container according to one embodiment of the invention.

FIGS. 11 and 12 illustrate a fire extinguisher sleeves that fold over the fire extinguisher according to two embodiments of the invention.

FIGS. 13 and 14 illustrate a fire extinguisher enclosure configured to protect a fire extinguisher body from corrosion and/or environmental conditions according to one embodiment of the invention.

FIG. 15 illustrates a fire extinguisher sleeve that has Braille writing attached thereto for visually impaired users according to one embodiment of the invention.

FIG. 16 illustrates a fire extinguisher sleeve that can protect a fire extinguisher from damage from a fall or impact according to one embodiment of the invention.

FIG. 17 illustrates a fire extinguisher sleeve that houses or holds a smoke detector, a carbon dioxide detector, a fire or extreme temperature detector, and/or alarm according to one embodiment of the invention.

### DETAILED DESCRIPTION

In the following description numerous specific details are set forth in order to provide a thorough understanding of the invention. However, one skilled in the art would recognize that the invention might be practiced without these specific details. In other instances, well known methods, procedures, and/or components have not been described in detail so as not to unnecessarily obscure aspects of the invention.

In the following description, certain terminology is used to describe certain features of one or more embodiments of the invention. For instance, the term “container” refers to any enclosure of any shape or size capable of storing fire extinguishing or retarding material. The terms “fire extinguisher” or “extinguisher” refer to any container or device whose function is to extinguish a fire. The term “graphics” includes any image, lines, colors, letters, and/or other symbols. The terms “sleeve” and “shell” are used to refer to any material that partially or fully covers, surrounds, or encloses the surface of a fire extinguisher and may be used interchangeably.

One feature of the invention provides a sleeve that slides over a fire extinguisher to cover its original color with a more desirable color, image, and/or pattern. The sleeve is designed to slide over the fire extinguisher container for easy installation and off the fire extinguisher container to permit inspection or maintenance of the extinguisher or replacement of the sleeve. The sleeve may be of various colors and include images, graphics, or words that customize it for a particular environment or use. For example, various embodiments of the invention may include a sleeve that has a particular sports team logo, wallpaper pattern, cartoon character image, person's image, and/or graphics.

Another feature of the invention also provides a sleeve that includes a window through which instruction, words, numbers, content, and/or warning labels on the fire extinguisher can be seen.

In one embodiment of the invention, the sleeve may be sufficiently thick to form a protective barrier to protect the fire extinguisher from damage or impact. In one embodiment of the invention, the sleeve is made of a thermally non-conductive and/or fire resistant material so that the fire extinguisher can be handled even when it has been exposed to heat.

Yet another feature of the invention provides for a sleeve that includes fluorescent material to improve the visibility of the sleeve and fire extinguisher in the darkness.

An embodiment of the invention also provides a sleeve that includes a folding end that adapts and covers a tapered end of a conventional fire extinguisher.

Another embodiment of the invention provides a sealed fire extinguisher shell that protects the fire extinguisher body from water and/or moisture to help extend its useful life.

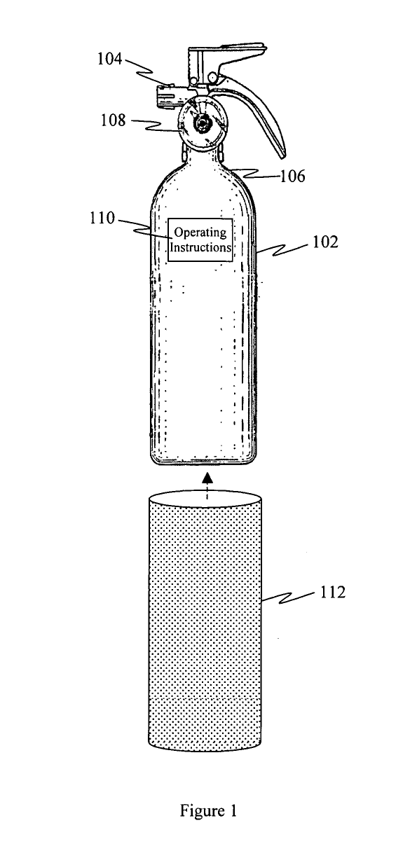

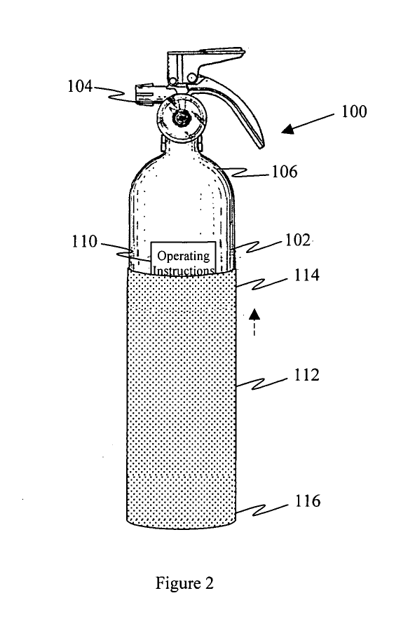

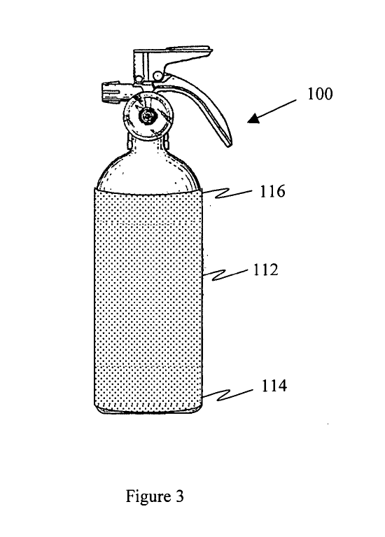

FIGS. 1, 2, and 3 illustrate the installation of a sleeve over a conventional, cylindrically-shaped fire extinguisher container according to one embodiment of the invention. A conventional fire extinguisher includes a cylindrical container 102, with a spray nozzle 104 coupled to a tapered end 106 of the fire extinguisher container. The spray nozzle may also include a gauge 108 indicating the pressure, amount, or condition of the fire extinguishing material inside the container 102. The fire extinguisher may also include one or more labels 110 to display operating instructions, type, warnings, or other information. Note that various embodiments of the invention may be implemented on fire extinguisher containers of different shapes and sizes, not just cylindrically-shaped containers.

The fire extinguisher sleeve 112 is shaped to conform to the fire extinguisher container 102 and can be made of a flexible, semi-rigid, or rigid material. As illustrated in FIGS. 1-3, the sleeve 112 slides over the fire extinguisher container 102 to cover the surface of the container 102. According to various embodiments of the invention, the outer surface of the sleeve 112 may include various colors and/or images, graphics, and/or words. Thus, a sleeve serves to cover a significant portion of the outer (visible) surface of the fire extinguisher 100. Since the visible surface of the sleeve 112 may be of different colors and/or have different images, graphics, and/or designs thereon, it can be customized for a particular environment or use. In this manner the sleeve serves the purpose of disguising, concealing, and/or making the fire extinguisher more aesthetically pleasing within the given environment in which it is used. For example, the sleeve 112 may be a chromed color, a wallpaper pattern, include a sports team logo, and/or any other graphic.

According to one embodiment of the invention, the sleeve 112 may have a predetermined size (e.g., dimensions, diameter, etc.) and shape (e.g., cylindrical, etc.) to fit convention fire extinguisher containers 102. In one embodiment of the invention, the size and/or shape of the sleeve 112 is designed so that the sleeve 112 fits tightly or snuggly around the extinguisher 102 and is kept in place by the friction between the inner surface of the sleeve 112 and the outer surface of the container 102.

In another embodiment of the invention, a first end 116 of the sleeve 112 has a slightly smaller diameter or dimensions than the second end 114 of the sleeve 112. For example, a fire extinguisher 100 may slide into the sleeve 112 on the second end 114 and the first end 116 of the sleeve tightens around the bottom end of the extinguisher to stay in place.

In yet other embodiments of the invention, other means may be employed to secure the sleeve 112 to the fire extinguisher without departing from the invention.

Another feature of the sleeve 112 is that it can be easily removed from the fire extinguisher 100, without destroying the sleeve, by sliding it off. This may be necessary from time to time for inspection, maintenance, and/or replacement of the fire extinguisher.

Additionally, another feature of the sleeve 112 is that is does not interfere with the regular use and deployment of the fire extinguisher. That is, the fire extinguisher can still be mounted on any bracket or cabinet, it can be carried or handled, and the spray nozzle 104 can be operated to release the extinguishers content when desired.

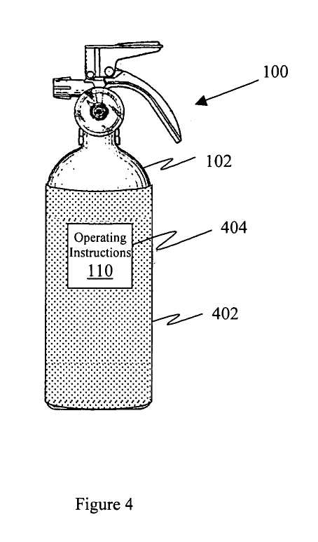

FIG. 4 illustrates a fire extinguisher sleeve having a see-through window according to one embodiment of the invention. In some instances it may be desirable to view operating instructions or warning labels 110 mounted on the container 102 even when a sleeve 402 has been installed. As illustrated, the sleeve 402 is mounted on a fire extinguisher 100. The sleeve 402 has a window 404 through which a label 110 on the fire extinguisher container 102 can be seen and/or read.

According to one embodiment of the invention, the window 404 may be a cutout in the sleeve 402. This window cutout 404 may be made upon manufacturing of the sleeve 402 or upon installation of the sleeve 402 on the fire extinguisher 100.

In another embodiment of the invention, the window 404 may be a see-through material on the sleeve 402. Such see-through window 404 may be formed during manufacturing of the sleeve 404 or upon installation of the sleeve as necessary. For instance, according to one embodiment of the invention, the see-through window 404 may be formed by scratching or removing a layer or coating material from the inside surface and/or outside surface of the sleeve 402 to reveal a see-through layer that serves as the window 404. Thus, the window 404 can be sized according to the label 404 for each installation.

In yet another embodiment of the invention the window 404 may be slot or frame in which a label, business card, or picture may be inserted. This slot may allow fire extinguisher maintenance companies to insert their business cards on the fire extinguisher sleeve.

Another embodiment of the invention provides a fire extinguisher sleeve having a writing area so that information (e.g., inspection record, location, etc.) can be written directly on the sleeve. Another embodiment of the invention provides a flap or cover on part of the sleeve that can be opened to reveal the writing area.

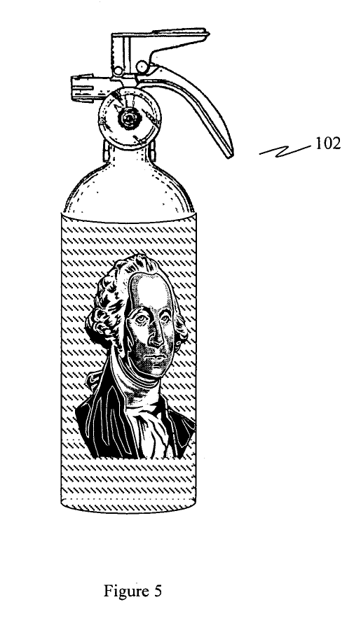

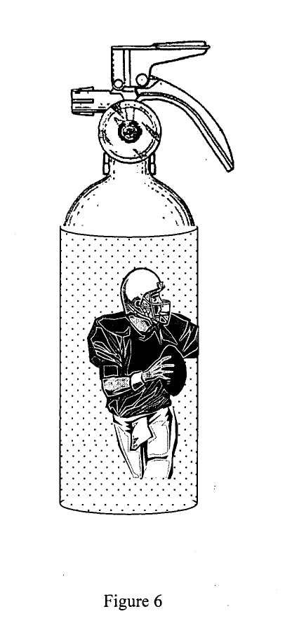

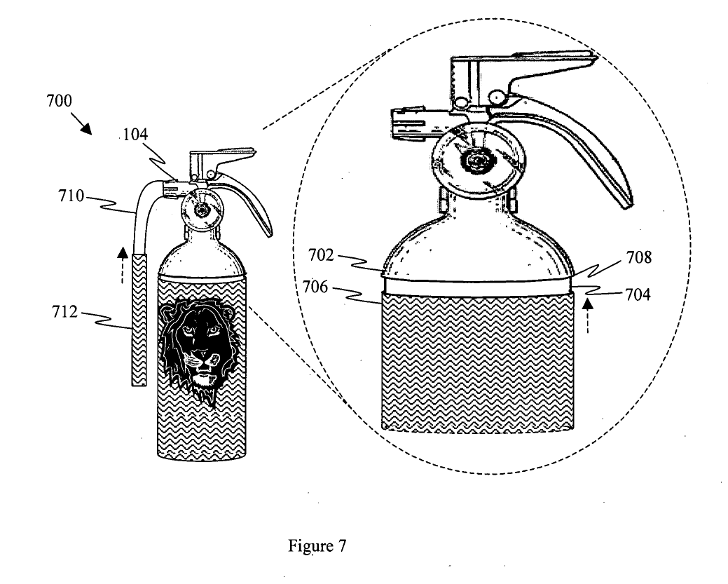

FIGS. 5, 6, and 7 illustrate various sleeve designs, graphics, or images according to various embodiments of the invention. Various embodiments of the invention may include a sleeve that has a particular sports team logo, wallpaper pattern, cartoon character image, person's image, and/or graphics. For example, FIG. 5 illustrates a sleeve having the image of a person (e.g., George Washington) thereon. FIG. 6 illustrates a sleeve having the image of a sports figure or sports team thereon. FIG. 7 illustrates a sleeve having an animal's image (e.g., lion) thereon. The types and numbers of images, graphics, colors, and/or textures that can be placed on the sleeve are not limited by the invention. Ultimately, the fire extinguisher sleeves enables any type of image, words, advertising, logos, etc. placed on a fire extinguisher to be removable.

FIG. 7 also illustrates a type of fire extinguisher 700 formed by a cylindrical container 704 with a top portion 702 coupled to it. The diameter of the cylindrical container 704 is typically slightly smaller than the top portion 702. According to one embodiment of the invention, the sleeve 706 is designed to slide onto the cylindrical container 704 and abut to the edge of the top portion 702; the outer surface of the sleeve 706 being substantially flush with the outer surface of the top portion 702. Some cylindrical containers 704 include a lip 708 between the cylindrical body 704 and the dome or top portion 702. When installed, the outer surface of the sleeve 706 is substantially flush with the outer surface of the dome or top portion 702.

According to various embodiments of the invention the fire extinguisher sleeve may be formed of one or more layers of material. For example, a sleeve may be a single layer of plastic, paper, film, or cardboard material on which paint or an image is coated. In other embodiments of the invention, the sleeve may include a plurality of layers of the same or different materials.

Yet another feature of the invention provides a decorative and/or protective hose sleeve 712 for a fire extinguisher hose 710. Fire extinguisher hoses 710 are typically coupled to the spray nozzle 104 on the head of the fire extinguisher 700. This hose 710 is typically made of a rubber-like material and is sufficiently flexible to permit directing it to a desired location. The decorative and/or protective sleeve 712 serves to make such fire extinguisher blend into an environment. The sleeve 712 may cover a portion or all of the hose 710. Since the hoses 710 are typically black in color, a decorative sleeve 712, having a desired color or features, serves to make the hose 710 blend into an environment. The sleeve 712 may slip on or wrap around the hose 710 and may be kept in place by friction or an adhesive. The sleeve 712 may be made of a flexible material that permits it and the hose 710 to bend or be directed towards a desired location. In one embodiment of the invention the decorative hose sleeve 712 matches the color, texture, and/or appearance of the sleeve 706. In one embodiment of the invention, the sleeve may be made of a weaved metallic fiber that protects the hose 710 from cuts or other damage.

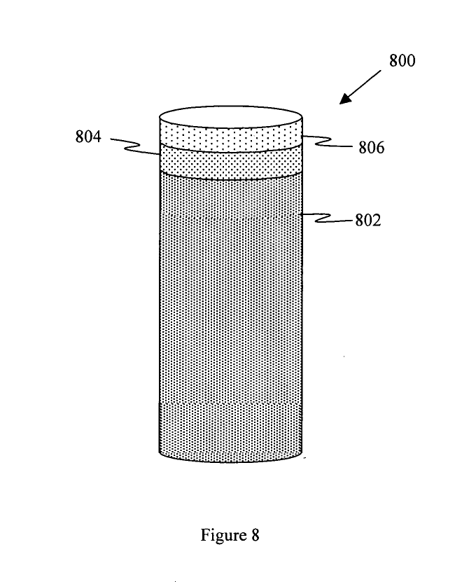

FIG. 8 illustrates a fire extinguisher sleeve 800 having a plurality of layers according to one embodiment of the invention. According to one embodiment of the invention, an outer layer 802 may be simply a see-through protective layer. A second layer 804 may be an image, pattern, color, or graphic which is visible through the outer layer 802. An inner layer 806 may be a padded material, such as rubber or sponge-like materials, that serves to adhere the sleeve to the fire extinguisher by friction or otherwise.

Yet another feature of the invention provides that the outer surface of the fire extinguisher sleeve be textured as desired. The fire extinguisher sleeve may be textured to match the environment where the fire extinguisher is used or to provide a better grip of the fire extinguisher during use. For example, the sleeve may have an outer layer made of a rubber material that improves gripping of the fire extinguisher.

Another feature of the invention provides a fire extinguisher sleeve that includes a visible fluorescent or glow-in-the-dark coat or material. This fluorescent coat makes the fire extinguisher sleeve visible in dark environments thereby making it easier to locate a fire extinguisher in darkness. For instance, the sleeve may be partially or completely painted and/or coated using a fluorescent or equivalent material that makes it glow or permits seeing the sleeve in the darkness.

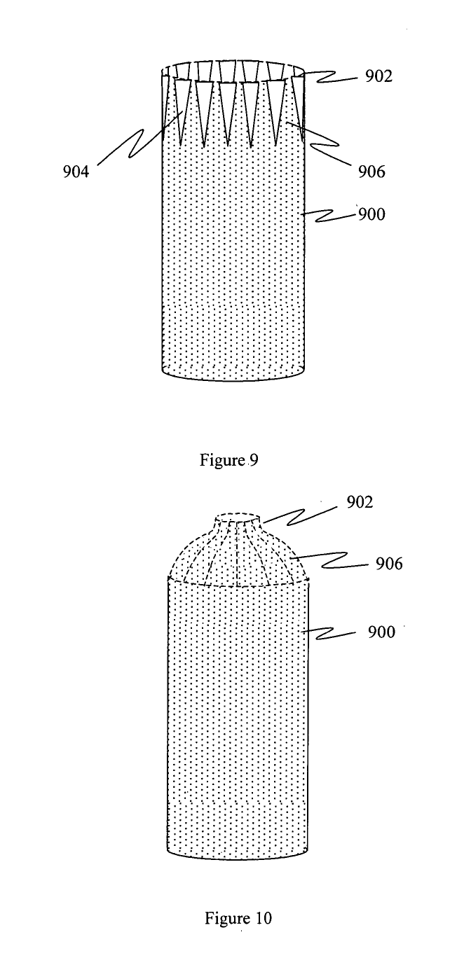

FIGS. 9 and 10 illustrate another embodiment of the fire extinguisher sleeve having a first end 902 that can be tailored to cover the neck portion of a fire extinguisher container according to one embodiment of the invention. A first end 902 of the sleeve 900 includes a plurality of slits 904 and corresponding fingers 906. The fingers 906 can be folded back to slide the sleeve 900 over a fire extinguisher container. Then, the fingers 906 can be folded over the neck portion of the fire extinguisher container to cover it. A C-clamp, ring clamp or other retaining mechanism may be used to secure the fingers 906 around the neck of the fire extinguisher container.

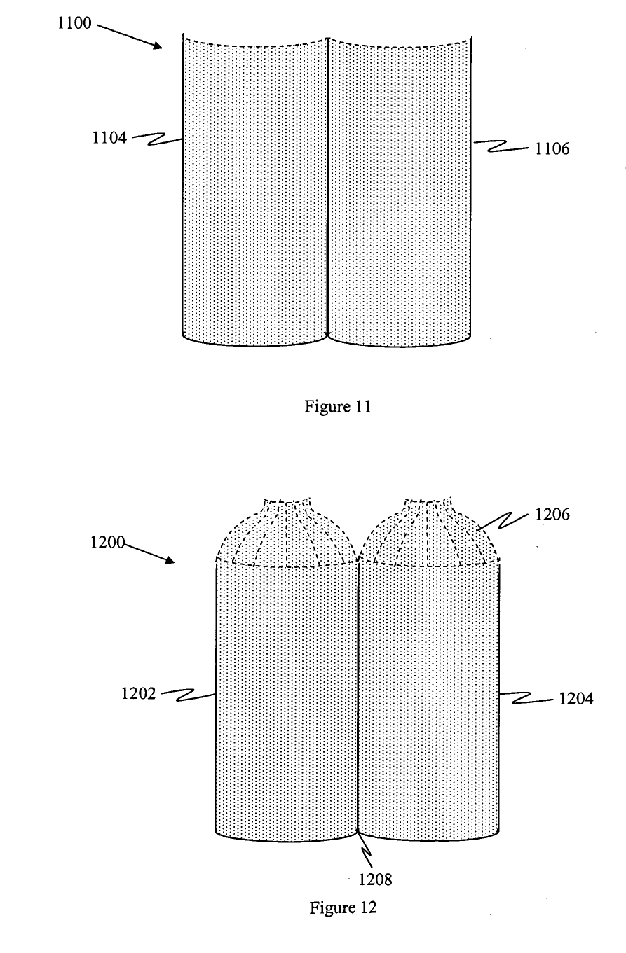

FIGS. 11 and 12 illustrate a fire extinguisher sleeves that fold over the fire extinguisher according to two embodiments of the invention. Sleeve 1100 includes two portions 1104 and 1106 that fold along a line 1102. The two portions 1104 and 1106 may be preformed in the shape of a fire extinguisher container so that they can be mounted on a fire extinguisher. Various securing means may be used to secure both portions 1104 and 1106 to each other and/or to the fire extinguisher to keep the sleeve 1100 in place. For example, clamps, Velcro, adhesive materials, finger joints, etc., may be used to install the sleeve 1100 on a fire extinguisher. In yet other embodiments of the invention, the sleeve 1100 is just a sheet that is wrapped around a fire extinguisher.

FIG. 12 illustrates a fire extinguisher sleeve with pre-shaped neck regions according to one embodiment of the invention. A first portion 1202 folds over a second portion 1204 along a fold line 1208 to mount the sleeve 1200 on a fire extinguisher. The first and second portions 1202 and 1204 include pre-shaped neck regions 1206 to cover the neck of the fire extinguisher when installed. The first portion 1202 and second portion 1204 may be joined by a zip-lock mechanism, snap-locks, or any other fastening or coupling devices.

One feature of the invention provides a sleeve that protects a fire extinguisher from dents or scratches. Such sleeve may include a rubber, plastic, foam, or other protective material that serves to reduce the chances that the extinguisher would dent or scratch. Preventing scratches or dents to the fire extinguisher is important since scratches or dents may cause a fire extinguisher to deteriorate or malfunction.

Fire extinguishers are typically made of a metallic material that may become hot when the fire extinguisher is exposed to sun or heat. One embodiment of the invention provides a fire extinguisher sleeve that includes an insulated or thermally non-conductive material that does not become hot when exposed to the sun or heat (e.g., as when near a fire). The fire extinguisher sleeve may also include or be made of a fireproof or fire-resistant material so that it can protect the fire extinguisher in harsh environments.

Yet another embodiment of the invention provides a sealed sleeve enclosure to keep moisture or water away from the fire extinguisher container thereby preventing or inhibiting corrosion of the fire extinguisher container. In harsh environmental conditions, such as those experienced in marine environments, fire extinguishers are exposed to water and/or salt which tend to cause corrosion of the fire extinguisher body or container. Similarly, fire extinguishers that are installed outside a home or building are also exposed to water, moisture, and the elements. Such exposure to the elements causes accelerated failure of the fire extinguisher container, through corrosion and otherwise.

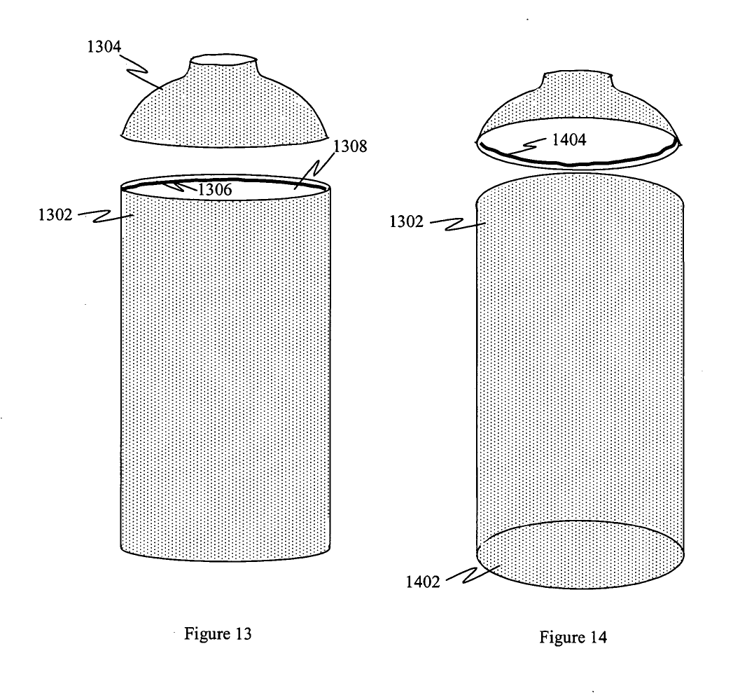

FIGS. 13 and 14 illustrate a fire extinguisher enclosure 1300 configured to protect a fire extinguisher body from corrosion and/or environmental conditions according to one embodiment of the invention. The enclosure or shell 1300 is used to cover and/or protect exposed parts of the fire extinguisher from water, moisture, and/or other elements. In one implementation, the shell 1300 may be made from a non-corrosive material that is impermeable to water and/or moisture. According to one embodiment of the invention, the shell 1300 includes a bottom portion 1402 that covers the bottom of the fire extinguisher, a side portion 1302 that cover the sides of the fire extinguisher, and a top portion 1304 that covers the neck portion of the fire extinguisher. Having all three of these portions is not essential to the invention and other embodiments of the invention include just one or two of these portions to protect just part of the fire extinguisher as desired or necessary.

The bottom portion 1402 and side portion 1302 of the sleeve may be a single piece that slips onto a fire extinguisher. The sleeve 1300 may include a seal 1306 along the edge of the opening 1308 to prevent water or moisture from reaching the protected part of the fire extinguisher container. In one embodiment of the invention, the top portion 1304 slides over or covers the lip of the side portion 1302 of the sleeve to keep water or moisture out. The top portion 1304 may include another seal 1404 that seals around the outer surface of the side portion 1302 to prevent water or moisture from reaching the fire extinguisher.

In one embodiment of the invention the top portion 1304 may be installed during manufacturing of the fire extinguisher prior to installation of the fire extinguisher valve. The top portion 1304 may be made of a flexible material so that the top portion 1304 can be rolled back when necessary for inspection. In another embodiment of the invention the top portion 1304 may be split along a line so that it can be mounted on the fire extinguisher. A moisture or water proof seal is used along the split to prevent moisture from reaching the fire extinguisher.

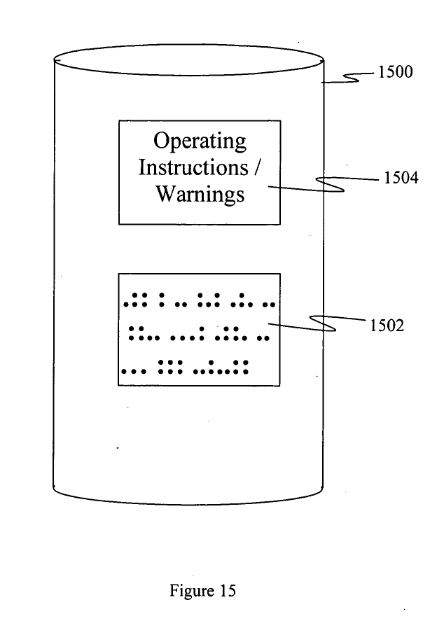

FIG. 15 illustrates another embodiment of the invention where a fire extinguisher sleeve 1500 has Braille writing 1502 (e.g., instructions or warnings) attached thereto for visually impaired users. Such sleeves may have the Braille writing 1502 directly on it or may have a label with Braille writing attached thereto.

Yet another feature of the invention provides audio instructions or warnings on how to use the fire extinguisher. Such audio instructions or warnings may be stored in an audio storage device coupled to the fire extinguisher or the fire extinguisher sleeve. Such audio instructions may be activated upon detection that the fire extinguisher has been moved or by a button or switch that is activated to play the audio stored in the storage device.

Another embodiment of the invention provides a fire extinguisher sleeve having a plurality of instructions or warnings 1504 in a plurality of languages. Such multi-linguistic warnings may be useful for fire extinguishers in various types of locations frequented by travelers, etc. (such as resorts, hotels, restaurants, airports, etc.).

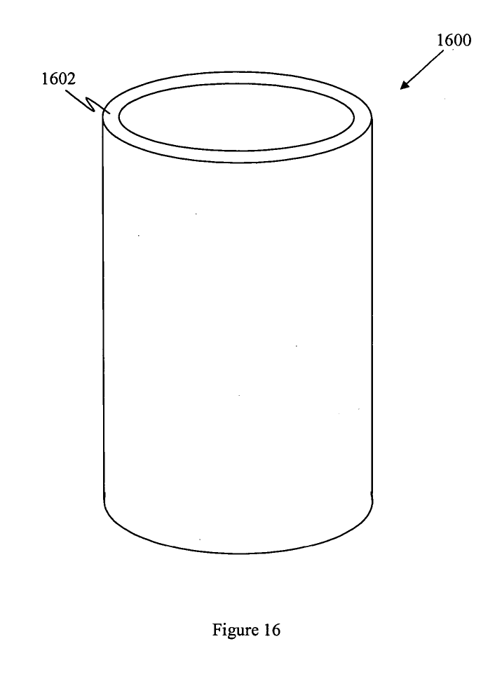

FIG. 16 illustrates a fire extinguisher sleeve 1600 that can protect a fire extinguisher from damage from a fall or impact according to one embodiment of the invention. To this end, the fire extinguisher sleeve 1600 may have walls 1602 of up to a few inches thick and be constructed from one or more materials (e.g., foam, rubber, plastic, air-pockets, etc.) that provide protection against impacts or falls.

Another embodiment of the invention provides a fire extinguisher sleeve configured to hold or house one or more devices. For example, in one embodiment of the invention, the sleeve may serve to hold a thermostat or clock visible on the exterior of the sleeve. Additionally, the sleeve may house a power supply (e.g., battery) and hold one or more light emitting diodes (LEDs) or other light-emitting elements visible on the exterior of the sleeve. The LEDs may be turned On upon activation of a switch, when the fire extinguisher is moved, or by a light-sensitive cell that turns the lights On when it gets dark.

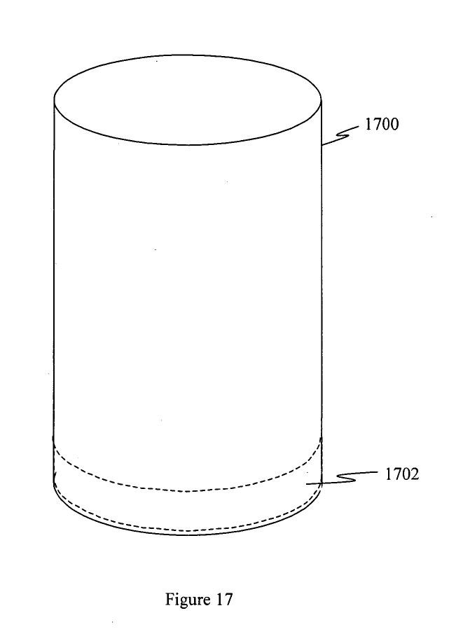

FIG. 17 illustrates another embodiment of the invention providing a fire extinguisher sleeve 1700 that houses or holds a smoke detector, a carbon dioxide detector, a fire or extreme temperature detector, a light source, an alarm, and/or other electrical/electronic devices 1702. One or more such detectors or light 1702 can be mounted at the bottom of the sleeve 1700 so that it sits at the bottom of the fire extinguisher when installed. Such devices 1702 may be powered by a power source, such as a battery, contained as part of the device. An On/Off or Reset switch may be available for the electrical/electronic devices 1702 either on the bottom of the sleeve 1700 or at some other accessible region.

In yet other embodiments of the invention, a speaker and audio playback device is mounted on the sleeve. Such audio device may be configured to play audio instructions, warnings, and other information in one or more languages.

In yet another embodiment of the invention, a fire extinguisher sleeve may include a fragrance-retaining material that permits it to retain various smells or fragrances. The fragrance retaining material may include a sponge, cardboard, or other material that releases a scent over a period of time and may be an integral part of the fire extinguisher sleeve. Thus, the fire extinguisher sleeve can serve to deliver a fragrance to the particular environment or act as an air freshener.

In yet other embodiments of the invention, the neck cover portion 906 and 1206 may be a separate part of the sleeve.

Note that one of the key features in the sleeve embodiments described herein is that sleeves can all -be easily, and non-destructively, removed from a fire extinguisher when necessary. However, the invention also encompasses sleeves that are glued or more permanently secured to the fire extinguisher and/or not easily removed.

Yet another feature of the invention provides a hood or cover for the extinguisher spray nozzle 104 that covers the extinguisher handle and valve body. This hood is removable to permit easy access to the handle and valve body during operation of the fire extinguisher. One embodiment of the invention may provide an access window through which the extinguisher pressure gauge remains viewable when the hood is installed. The hood permits to conceal or further blend an extinguisher within a particular environment. However, it is easily removable when the fire extinguisher is operated.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A fire extinguisher sleeve comprising:
a shell conforming to the shape of a fire extinguisher body and configured to be maintained by friction against the fire extinguisher body; and
a first material layer deposited on the shell, the first material layer having a different color than the fire extinguisher body to modify the appearance of the fire extinguisher.

2. The fire extinguisher sleeve of claim 1 wherein the shell forms a waterproof seal against the fire extinguisher body.

3. The fire extinguisher sleeve of claim 1 wherein the shell is sufficiently thick to protect the fire extinguisher body from impact.

4. The fire extinguisher sleeve of claim 1 wherein the shell can be removed from a fire extinguisher intact.

5. The fire extinguisher sleeve of claim 1 further comprising:
a Braille label coupled to the shell.

6. The fire extinguisher sleeve of claim 1 wherein the shell includes a non-thermally conductive material.

7. The fire extinguisher sleeve of claim 1 further comprising:
one of either a smoke detector, a carbon dioxide detector, a fire or extreme temperature detector, a light source, or an alarm coupled to the shell.

8. The fire extinguisher sleeve of claim 1 wherein the shell includes a see-through window that, when the shell is installed on a fire extinguisher, permits viewing labels attached to the fire extinguisher surface.

9. The fire extinguisher sleeve of claim 1 wherein the shell includes two or more parts that attach to each other to form the shell.

10. A fire extinguisher comprising:
a fire extinguisher container; and
an outer sleeve that covers part of the fire extinguisher container, wherein the outer sleeve can be slid on and slid off the fire extinguisher container intact, the outer sleeve forming a waterproof seal around the covered part of the fire extinguisher container.

11. The fire extinguisher of claim 10 wherein the outer sleeve is a different color than the fire extinguisher container and includes a graphic, picture or design.

12. The fire extinguisher of claim 10 wherein the outer sleeve is shaped to cover a neck portion of the fire extinguisher container.

13. The fire extinguisher of claim 10 wherein the outer sleeve has a fluorescent material that makes it visible in the darkness.

14. The fire extinguisher of claim 10 wherein the outer sleeve is of sufficient thickness to protect the fire extinguisher container from damage during a fall.

15. The fire extinguisher of claim 10 wherein the outer sleeve is textured on an exterior surface to provide improved gripping of the fire extinguisher.

16. The fire extinguisher of claim 10 wherein the outer sleeve can be separated into two or more parts along a folding line.

17. The fire extinguisher of claim 10 wherein the sleeve is made of a rigid material.

18. The fire extinguisher of claim 10 wherein the sleeve includes an inner layer that increases the sleeve's adhesion to the fire extinguisher container.

19. A decorative and removable fire extinguisher cover comprising:
an outer sleeve having a cylindrical shape and sized to cover at least a portion of a fire extinguisher body, wherein the outer sleeve can be maintained by friction against the fire extinguisher body, the outer sleeve can also can be installed and removed from the fire extinguisher body intact, the outer sleeve forming a waterproof seal around the covered part of the fire extinguisher container, the outer sleeve being fluorescent in the darkness.

20. The decorative and removable fire extinguisher cover of claim 19 wherein the outer sleeve has a different color than the fire extinguisher body, the outer sleeve is constructed from a non-thermally conductive material, the outer sleeve has a color or graphic visible on its external surface that modifies the appearance of the fire extinguisher body, and a hose sleeve to cover at least a portion of a hose coupled to the fire extinguisher body.
